(19) United States
(12) Patent Application Publication
(10) Pub. No.: US 2009/0087681 A1
(43) Pub. Date: Apr. 2, 2009

(54) HIGH IMPACT RESISTANT METAL ALLOY PLATE

(76) Inventors: Raymond F. Decker, Ann Arbor, MI (US); Sanjay Kulkarni, Livonia, MI (US); Joseph R. Pickens, Glenelg, MD (US)

Correspondence Address: Brinks Hofer Gilson & Lione/Ann Arbor, 524 South Main Street, Suite 200, Ann Arbor, MI, 48104, US

(21) Appl. No.: 12/138,939

(22) Filed: Jun. 13, 2008

Related U.S. Application Data
(60) Provisional application No. 60/943,704, filed on Jun. 13, 2007.

(51) Int. Cl. B32B 15/04; B32B 9/04; B32B 5/02; B32B 7/02; B32B 37/10; B32B 37/12; B32B 37/06; B23K 28/00; B23K 20/12

(52) U.S. Cl. 428/649; 428/457; 428/472; 428/472.2; 428/469; 428/450; 442/1; 428/212; 156/60; 156/305; 156/73.5; 428/651; 428/653; 228/101; 228/193; 228/112.1

(57) ABSTRACT

An impact resistant composite member is for at least one of armor plate and an impact resistant structure. The member comprises a body in plate form and a reinforcement structure located within the body. The body includes a metal alloy having a fine grain size of about 5 microns or less.

### CROSS REFERENCE TO RELATED APPLICATIONS

This application claims priority to U.S. provisional patent application 60/943,704 filed Jun. 13, 2007, the entire contents of which are herein incorporated by reference.

### STATEMENT OF GOVERNMENT SUPPORT

This invention was made with support from the U.S. Government under Contract No. W911 QX-08-C-0039 awarded by the U.S. Army RDCOM Acquisition Center-Adelphi at 2800 Powder Mill Road, AMSRD-ACC, Adelphi, MD. 20783-1197. The U.S. government has certain rights in this invention.

### BACKGROUND OF THE INVENTION

1. Field of the Invention

The present invention relates to a high impact resistant metal alloy plate, which may be used as armor plate or as a structure for other high impact energy management applications, and a method for making the high impact resistant metal alloy plate.

2. Description of the Related Technology

Lighter weight high impact resistant materials are needed for vehicles. For example, the U.S. military needs lighter weight structural materials for future combat and tactical vehicles. In yet another example, commercial vehicle manufactures need lighter weight reinforcing materials for structures in the “crush zone” of the vehicle to assist in managing impact energy produced during a collision.

Both Magnesium (Mg) and Aluminum (Al) represent light commercial metals for structural and defense applications, Mg being the lighter of the two. However, high impact resistant applications require materials with sufficient strength and ductility to absorb the energy generated during an impact. This requirement may limit the use of conventional Mg and Al alloys for such applications. For example, existing conventional Mg alloys have low yield strengths of about 130-180 MPa, have poor formability and have poor crack tolerance. These properties make conventional Mg alloys unsuitable for armor on many combat, tactical and security vehicles because the alloy is more likely to crack after only moderate deformation when impacted with a high speed projectile. These properties might also make conventional Mg unsuitable for body armor or armor on air vehicles including fixed wing and rotary craft.

Accordingly, there is a need for impact resistant structures made from lighter weight metal alloy materials with sufficiently high strength, ductility and ballistic damage tolerance.

### SUMMARY OF THE INVENTION

In satisfying the above need and overcoming the above and other drawbacks and limitations of the known technology, the present invention provides a high-velocity impact resistant composite member for an armor plate or an impact resistant structure. The composite member comprises a body and a reinforcement structure located within the body. Additionally, the body is in plate form and formed of a metal alloy having a fine grain size of about 5 microns or less.

In one aspect, the metal alloy has a fine grain size of about 1-3 microns.

In another aspect, the metal alloy is one of magnesium base alloy and an aluminum base alloy.

In yet another aspect, the reinforcement structure is formed of a titanium alloy.

In another aspect, the reinforcement structure is formed of steel.

In further aspect, the reinforcement structure is formed of a ceramic material.

In one aspect, the ceramic material is one of aluminum oxide, titanium diboride, silicon carbide, silicon nitride and boron carbide.

In yet another aspect, the body is formed of a plurality of layers.

In a further aspect, the reinforcement structure is formed of a plurality of layers.

In another aspect, at least one of the layers of the reinforcement structure includes ceramic bodies in a metal alloy sheet.

In a further aspect, the ceramic bodies are configured as one of disks and spheres.

In one aspect, another one of the layers of the reinforcement structure includes one of a wire mesh, fiber mesh and grid.

In a further aspect, the reinforcement structure includes a high strength metal alloy sheet that is formed from a metal alloy having a higher strength and a lower ductility than the metal alloy of the body.

In one aspect, the high strength metal alloy sheet is formed from magnesium alloy containing at least one of aluminum and zinc.

In another aspect, the high strength metal alloy sheet forms one side of the plate form and the metal alloy of the body forms an opposing side of the plate form.

In at least one other embodiment of the present invention, a method of forming a high-velocity impact resistant composite for armor plating or an impact resistant structure is provided. The method comprises providing a plurality of precursor members of a metal alloy material having a grain size about 5 microns or less. The grain size of the precursor members is refined to about 1-3 microns or less and the precursor members are formed into a plurality of precursor layers. A reinforcement structure is provided and located with the precursor layers to form a multilayer stack of an initial thickness. The layers of the multilayer stack are then bonded to form a bonded multilayer stack.

In one aspect, the step of locating the reinforcement structure includes positioning the reinforcement structure between two of the precursor layers.

In another aspect, the step of refining the grain size of the precursor members includes physically compressing the precursor members and reducing their thicknesses.

In a further aspect, the step of forming the reinforcement structure includes locating reinforcement bodies within one of the plurality of precursor layers.

In yet another aspect, the step of forming the reinforcement structure includes locating ceramic members within one of the plurality of precursor layers to form a reinforcement layer.

In yet another aspect, the step of forming the reinforcement structure includes forming a plurality of reinforcement layers.

In another aspect, the step of forming the reinforcement structure locates the ceramic members such that the ceramic members are offset from one another in adjacent reinforcement layers.

In one aspect, the step of locating the reinforcement structure includes positioning at least one precursor layer between two adjacent reinforcement layers to reduce interference and cracking of the ceramic members during the step of bonding the layers.

In a further aspect, the step of forming the reinforcement structure includes locating one of a wire mesh, fiber mesh and grid within one of the plurality of precursor layers to form a continuously reinforced layer and the step of locating the reinforcement structure includes positioning the continuously reinforced layer between two adjacent reinforcement layers, reducing distortion of the reinforcement layers during the step of bonding the layers.

In another aspect, the plurality of precursor members are formed of one of magnesium base alloy material and aluminum base alloy material.

In another aspect, the step of refining the grain size of the precursor members reduces their thickness by at least 50%.

In a further aspect, the step of bonding the layers of the multilayer stack includes physically compressing the multilayer stack thereby forming a bonded multilayer stack of reduced thickness.

In one aspect, the step of compressing the multilayer stack is done by superplastic press forming.

In one other aspect, the step of compressing the multilayer stack is done by roll bonding.

In another aspect, the step of bonding the layers of the multilayer stack further includes adhesively bonding the multilayer stack.

In yet another aspect, the step of bonding the layers of the multilayer stack further includes diffusion bonding the multilayer stack.

In a further aspect, the step of bonding the layers of the multilayer stack further includes weld stitching the multilayer stack.

In one other aspect, the step of bonding the layers of the multilayer stack further includes friction stir welding the multilayer stack.

In one aspect, the step of bonding the layers of the multilayer stack further includes heating the multilayer stack.

In another aspect, the step of bonding the layers of the multilayer stack further includes gradual cooling of the bonded multilayer stack to reduce delamination of the bonded multilayer stack.

In yet another aspect, the step of providing a plurality of precursor members provides precursor members formed of magnesium alloy material and the step of forming the reinforcement structure includes locating ceramic members within at least one of the plurality of precursor layers to form at least one reinforcement layer.

In yet a further aspect, at least two reinforcement layers are formed with the ceramic members therein and the step of forming the reinforcement structure further includes locating one of a wire mesh, fiber mesh and grid within one of the plurality of precursor layers to form a continuously reinforced layer and the step of locating the reinforcement structure includes positioning the continuously reinforced layer between the at least two reinforcement layers to reduce distortion of the reinforcement layers during the step of bonding the layers.

In at least one other embodiment of the present invention a method of forming a high-velocity impact resistant composite member for at least one of armor plate and an impact resistant structure is provided. The method comprises providing a plurality of precursor members of a metal alloy material having a grain size about 5 μm or less. The grain size of the precursor members is refined to about 1-3 μm or less to form a plurality of precursor layers. A reinforcement structure is formed including at least one reinforcement body that has a lower coefficient of thermal expansion (CTE) than a CTE of the metal alloy material. The reinforcement structure is located with the precursor layers to form a multilayer stack of an initial thickness. The layers of the multilayer stack are bonded to form a bonded multilayer stack. Bonding the layers includes squeeze shrink-fitting the at least one reinforcement body within the metal alloy material.

Further objects, features, and advantages of the present invention will become apparent from consideration of the following description and the appended claims when taken in connection with the accompanying drawings.

### BRIEF DESCRIPTION OF THE DRAWINGS

FIG. 1 is a schematic illustration of a processing cell in accordance with an embodiment of the present invention;

FIG. 2a is a photo of the grain microstructure of a metal alloy in accordance with an embodiment of the present invention;

FIG. 2b is a photo of the grain microstructure of a metal alloy in accordance with another embodiment of the present invention;

FIG. 3a a schematic representation of plan view of a formed plate in accordance with an embodiment of the present invention;

FIG. 3b is a cross-sectional view of the formed plate depicted in FIG. 3a;

FIG. 4 is a cross-sectional view of a formed plate in accordance with another embodiment of the present invention;

FIG. 5 is a cross-sectional view of a formed plate in accordance with one embodiment of the present invention; and

FIG. 6 is a cross-sectional view of a formed plate in accordance with another embodiment of the present invention.

### DETAILED DESCRIPTION OF THE INVENTION

Detailed embodiments of the present invention are disclosed herein. It is understood however, that the disclosed embodiments are merely exemplary of the invention, which may be embodied in various and alternative forms. The figures are not necessarily to scale; some figures may be configured to show the details of a particular component. Therefore, specific structural and functional details disclosed herein are not to be interpreted as limiting but merely as a representative basis for the claims and for teaching one skilled in the art to practice the present invention.

Recent breakthroughs by Thixomat, Inc. (Ann Arbor, Mich.) have created processes that increase the strength, ductility and formability of metal alloys, such as for example, Mg alloys. The key is a low cost bulk process to generate, for example, novel nanostructured Mg alloys with low texture, accomplished by Thixomat's fine-grained injection molding, known as Thixomolded® or Thixomolding®, followed by vigorous thermomechanical processing (deformation) by roll passes (TMP). Alloy design has uncovered novel compositions that are tuned to take advantage of the new process. Stacked Thixomolded sheet bars have been bonded and heavy rolling reductions have been accomplished in one pass, opening the way for production of large area sheet and plate stock. Furthermore, experiments by Thixomat have demonstrated the feasibility of incorporating bonded reinforcing mesh into the nanostructured Mg alloy matrix.

In order to meet the above, a technical objective is to attain 250 MPa yield strength, improved warm temperature formability, good corrosion resistance and superior high impact or ballistic performance in light weight (<31 lb/ft² e.g. per 1 inch thick plate) Mg alloys and composites. This is achieved with the present invention by using three cooperative strengthening mechanisms: a) micron grain size in the metal alloy matrix, b) nano dispersoids within those grains, and c) composite reinforcement using arrays of oxides, carbides, borides, nitrides, intermetallic shapes or steel shapes and/or mesh, and grids or fibers of the above materials.

The present invention uniquely combines alloying and mechanical processing variables with the geometry of composite arrays in order to verify feasibility and repeatability of producing the nanostructured alloy and composites thereof in dimensions that are preferably greater that 2″×2″×2″. Thus, the present invention uses the new Thixomolding® plus thermomechanical processing (collectively, “TTMP”) scheme and variables, as well as the matrix alloy composition and geometry of composite reinforcement of that matrix.

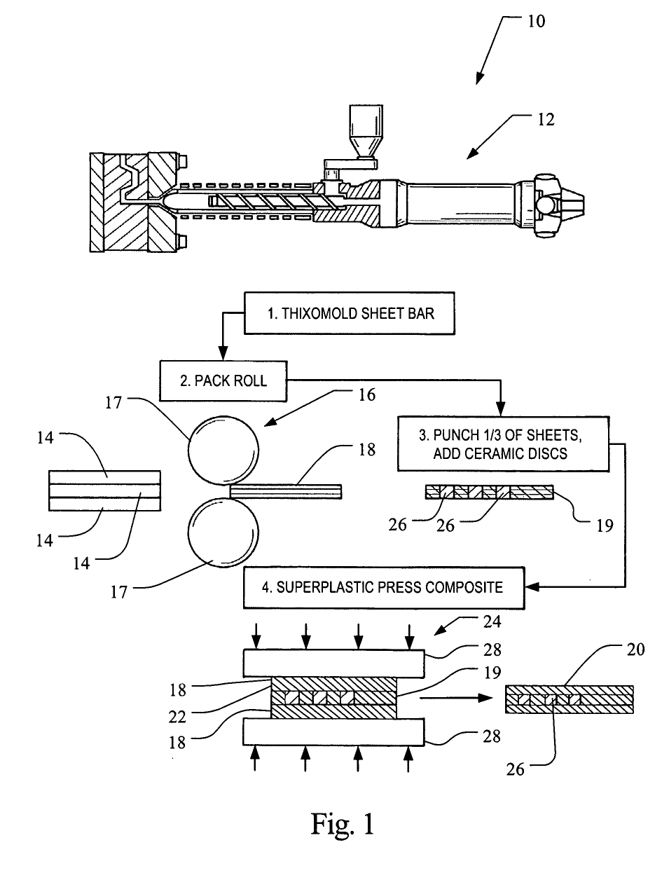

Referring to FIG. 1, a TTMP processing cell 10 is provided. The processing cell 10 includes a molding machine 12 for the metal injection molding of net-shaped sheet bar 14 which may be made of Mg alloy with <10 μm grain size and uniform microstructure.

The TTMP processing cell 10 refines the microstructure of the sheet bar 14 to one having less than 5 μm grains, and preferably less than about 1-3 μm grains, containing nanometer dispersed phases, by vigorous thermomechanical processing, such as for example, by severe rolling via rolls 17 of a rolling mill 16 to form a sheet form 18 that exhibits low texture, superior formability and superplasticity.

The TTMP processing cell 10 incorporates reinforcements 26, such as an array of steel, Al₂O₃, B₄C, or Si₃N₄ discs or spheres and/or Al₂O₃ or steel mesh or grid, at the stage of rolling via the rolling mill 16 or press forming the superplastic sheets via the press 24 as will be discussed in further detail below. In one embodiment, reinforcements 26 are inserted into the metal alloy sheet form 18 to form a reinforcement layer or sheet 19.

A plurality of sheet forms 18 may be stacked with one or more reinforcement layers 19 to form a stack of sheets 22. The TTMP processing cell 10 forms the final net-shaped plate 20 by superplastic press forming the stack of sheets 22, for example, with a compression press 24 to bond the sheets 18 and 19 together. Optionally, the sheets 18 and 19 may first be adhesively bonded, weld stitched or friction stir welded together to form the stack 22, which is then superplastically press formed.

In one embodiment, the compression press 24 may be configured to heat the stack of multiple sheets 22 prior to and/or during superplastic compression forming to further enhance bonding of the stack of sheets 22 to form the final net-shaped plate 20 (i.e. bonded stack of sheets). For example, the press 24 may have platens 28 that are configured to be heated and to conductively transfer heat to the stack of sheets 22.

In a further embodiment, the stack of sheets 22 may be heated and cooled either in the press 24 by cool platens 28 (e.g. not providing heat to the platens 28) or outside of the press 24 after compression. Preferably, gradual cooling (e.g. slow cooling) and/or step cooling is used, as opposed to rapid cooling or quenching, to allow the metal alloy of the sheets to mechanically relax, partially reducing stresses which may result from any thermal shrinkage mismatches between the metal alloy and the reinforcement 26. For example, the metal alloy material, e.g., Mg alloy, may have a higher thermal expansion coefficient (e.g. coefficient of thermal expansion or CTE) than the reinforcement, e.g., ceramic material. Upon cooling, the Mg alloy will shrink more per degree temperature drop than the ceramic material. However, because Mg alloy has lower strength and higher elongation or yield at higher temperatures, which is generally true for most metal alloys, gradual cooling allows more of the shrinkage mismatch between the ceramic reinforcement 26 and the Mg alloy to occur while the Mg alloy is at higher temperature and is more compliant. This reduces stress build-up within the sheets that could otherwise cause delamination or cracking between the reinforcements 26 and the metal alloy matrix during or after superplastic press forming. Moreover, Applicants have found that having a higher shrink factor metal alloy matrix with lower shrink factor reinforcements 26 incorporated therein, places the reinforcements 26 in compression within the metal matrix, which is believed to enhance the load transfer efficiency between the metal matrix and the reinforcement 26, thereby improving overall impact resistance. Applicants have termed this heating and gradual cooling process as “squeeze shrink-fitting.” Thus, the invention squeeze shrink-fits the reinforcement within the metal alloy matrix.

Two experiments performed by Applicants will now be described illustrating the stress reducing effects of gradual cooling on the net shaped plate 20 formed from heating and bonding the stack of sheets 22 that contain a plurality of lower CTE reinforcements 26 therein. In a first experiment, a stack of sheets 22 was superplastically compressed by the press 24 for one hour at 600° (F.) to form a heated net shaped plate 20. The stack of sheets 22 included several layers 18 of Mg alloy AZ61 interposed with reinforcing sheets 19 of Mg alloy AZ61 which included inserted ceramic pellets 26 of Al₂O₃. The stack of sheets 22 was reduced in total thickness by 33% during the superplastic compression cycle to form the heated net shaped plate 20. The heated plate 20 was removed from the press 24 for ambient cooling or free convection air quenching. Within about 5 minutes, Applicants observed that the plate 20 began delaminating, producing a loud “pinging” sound upon each occurrence of delamination within the plate 20.

In a second experiment, a heated net shaped plate 20 was produced with the same metal alloy and reinforcement composition and processing conditions as in the first experiment, except the heated plate 20 was not immediately removed from the press 24. Instead, the platens 28 of the press 24, which provided heat conductively to the stack of sheets 22 during compression, were turned off to gradually cool both the platens 28 and the heated plate 20 to near room temperature. The gradual cooling process took about one hour. Applicants discovered that by gradually cooling the heated plate 20 delamination of the bonded sheets 18 and 19, which occurred during rapid air quenching, was prevented. Notably, the ductile-to-brittle transition temperature for Mg alloys having a grain size of about 2-μm (typical of TTMP) is less than room temperature, whereas Mg alloys having a grain size of about 20-μm is at or above room temperature. Without limiting the scope of the invention, Applicants believe that the gradual cooling of the AZ61 Mg alloy allowed the still ductile metal matrix to compliantly squeeze or compress the Al₂O₃ pellets without building up significantly high delamination stresses between the pellets and the metal alloy that would otherwise be produced from their dissimilar CTE's during more rapid conventional cooling.

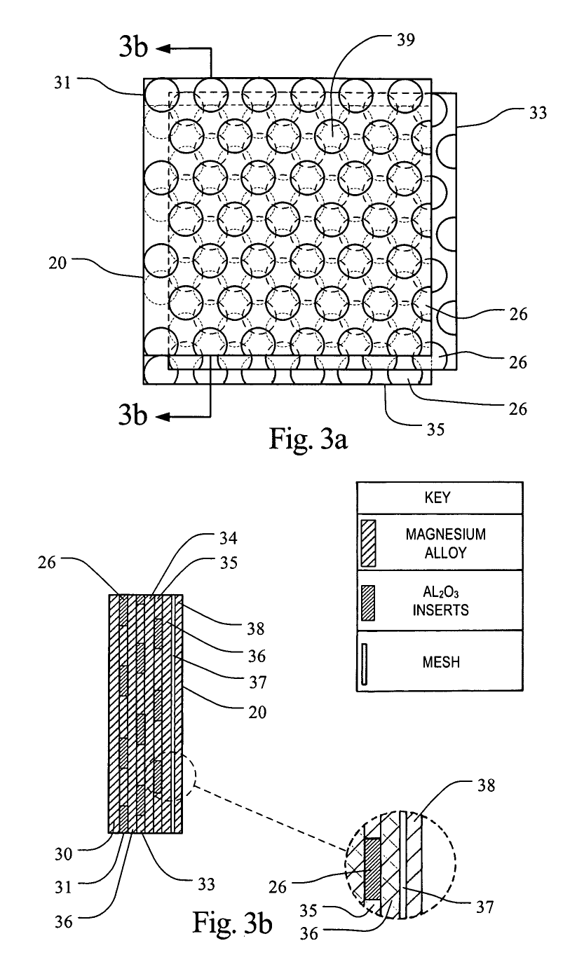

Referring to FIGS. 3a-6, various example constructions for the net shaped plate 20 will now be described. FIGS. 3a and 3b illustrate a multilayer plate 20 formed from bonded layers 30-38. The first, third, fifth, seventh and ninth layers 30, 32, 34, 36 and 38 are made from Mg alloy. The second, fourth and sixth layers 31, 33 and 35 are reinforcement layers made from Mg alloy containing reinforcements 26 of Al₂O₃ inserts. The reinforcement layers 31, 33 and 35 are interposed between the primarily metal alloy layers 30, 32, 34, 36 and 38. Moreover, the reinforcement layers 31, 33 and 35 may be stacked so that when viewed normal to a side face of the plate 20 (as illustrated in FIG. 3a) each of the Al₂O₃ inserts 26 in one layer are offset from another in an adjacent reinforcement layer to form a continuous reinforcing grid 39, which is believed to enhance impact resistance to an impacting projectile. Also, an eighth layer 37 is incorporated as a fiber or metal mesh and may be bonded, e.g., by roll bonding adhesively, to the adjacent metal alloy layers 36 and 38. The layer of mesh 37, preferably having a CTE between the metal alloy and the inserts 26, is believed to help dimensionally stabilize, e.g., prevent warpage due to shrinkage mismatch of the layers during cooling, and reinforce the plate 20 for further impact resistance.

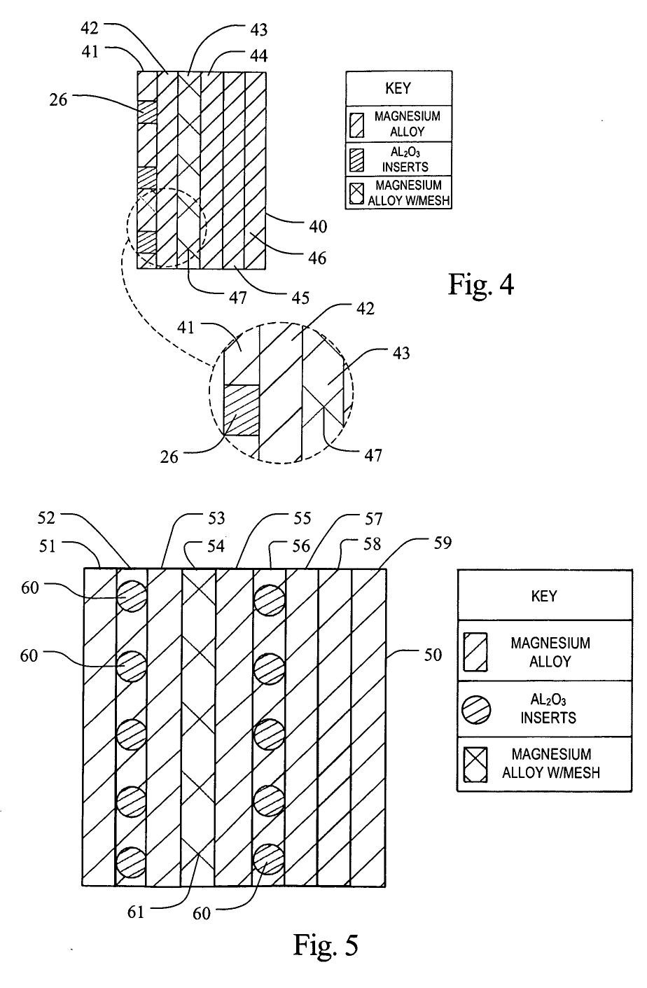

FIG. 4 illustrates an alternative construction for a net shaped plate 40 which is formed from bonded layers 41-46. The first layer 41 is a reinforcement layer made from Mg alloy containing reinforcements 26 of Al₂O₃ inserts. The second, fourth, fifth and sixth layers 42, 44-46 are made from Mg alloy. The third layer 43 is an alternative form of a reinforcement layer and includes a matrix of Mg alloy that is continuously reinforced with a fiber or metal mesh or grid 47. The continuously reinforced layer 43, which may have a CTE between the metal matrix and the inserts 26, is believed to help dimensionally stabilize and reinforce the plate 40.

Moreover, the metal matrix of the continuously reinforced layer 43 may further enhance bonding with the adjacent layer 42 and 44 to further improve impact resistance. For example, the mesh 47 may be made of steel. Applicants have found that the higher the strength of steel used for the mesh, the more the stack of layers forming the plate 40 may be reduced during warm or heated compression by the press 24. Increased reduction of the stack of layers further refines the grains of the metal matrix and improves bonding between the layers 41-46. Steels of low strength can include specific alloys in the classes of carbon steels and stainless steels. Steels of intermediate strength include tool steels such as H13. Steels of higher strength include Maraging steels such as 18 Ni 250, 300 and 350, Precipitation Hardening Stainless Steels such as 13-8 PH, Super Stainless Steels, 440C, Aeromet Steels and Super Bainitic Steels.

FIG. 5 illustrates another example construction for a net shaped plate 50 which is formed from bonded layers 51-59. The first, third, fifth and seventh-ninth layers 51, 53, 55 and 57-59 are made from a Mg alloy, for example, AZ61L. The second and sixth layers 52 and 56 are reinforcement layers made from a Mg alloy containing reinforcements 60 of spherically shaped Al₂O₃ or steel inserts. The spherical shape of the insert 60 are believed to minimize and/or reduce stress concentrations formed between the metal matrix and the reinforcement 60 thereby enhancing impact resistance of the plate 50. A fourth layer 54 is included as a reinforcement layer having a matrix of Mg alloy which is continuously reinforced with a fiber or metal mesh 61. Preferably, the thicknesses of the third, fourth and fifth layers 53, 54 and 55 are adequately thick prior to compression by the press 24, e.g., about 2 mm or greater, such that the reinforcements 60 do not interfere and contact each other during superplastic compression and, therefore, crack.

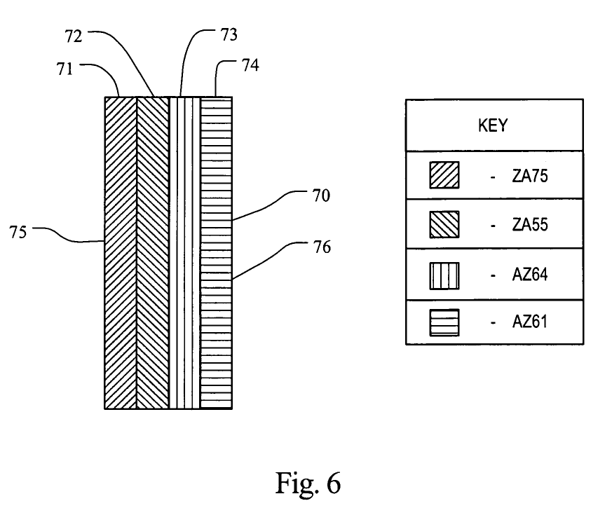

FIG. 6 illustrates yet another example construction of the net shaped plate 70 formed from a plurality of metal alloy layers 71-73. The first and second layers 71 and 72 are reinforcing layers which are made from higher strength and lower ductility metal alloys than the metal alloys of the third and fourth layers 73 and 74. In this example, the first through fourth layers are made respectively from magnesium/aluminum/zinc alloys ZA75, ZA55, AZ64 and AZ61. Accordingly, the first side face 75 of the net shaped plate 70 is formed from the layer 71 having the highest strength and lowest ductility metal alloy of the plate 70 and the second side face 76 is formed from the layer 74 having the lowest strength and highest ductility. This arrangement is believed to enhance impact resistance of the stack 70 when initially impacted on the first side face 75 from a projectile.

Preferably, the TTMP processing results in an inexpensive, light-weight plate 20 having a very high strength-to-weight ratio along with enhanced toughness and acceptable high impact resistance or ballistic performance.

On a microstructural level, the present invention begins by using Thixomolded® sheet bar that is un-textured and has a 5 μm grain size with low-angle grain boundaries and second phase particles that are generally coarse. To obtain this sheet bar precursor, alloy granules, preferably with primary intermetallic phase contents of about 6 volume % or less are introduced into the semi-solid metal molding machine (such as those employed by Thixomat) that processes and forms a thixotropic slurry. The temperature profile on the barrel of the molding machine and the die temperature are selected to preferably yield sheet bar with a grain size of ≦5 μm and no larger a particles. Injection speeds are anticipated to be in the range of 1.8 to 3.3 m/s and injection pressures at 60-80 MPa. The resultant die filling, surface finish microstructure and porosity need to be evaluated to ensure that a good sheet bar is achieved.

Severe slip deformation is thereafter imparted to the sheet bar to generate simultaneous recrystallization to micron-sized grains with high-angle grain boundaries.

Coarse intermetallic second phases are subdivided and/or dissolved/reprecipitated into nano-sized dispersoid arrays by thermomechanical processing of the sheet bar.

By continuous dynamic recrystallization to grain size of ≦3 microns, harmful twinning is minimized or eliminated, as is the generation of strong textures, which can adversely impact formability.

Arrays of steel, Al₂O₃, TiB₂, SiC, Si₃N₄ discs or other shapes of reinforcements, such as spheres, hexagons, parallelepipeds or other geometries, and Al₂O₃ or steel mesh or grid are bonded or inserted into the above matrix to form a reinforcing layer that resists impact or ballistic penetration.

Rolling and roll bonding of the sheet bars may be done via the rolling mill with reductions of 80% at 2 to 45 RPM at metal temperatures of 300° C. and rolls at 260° C. A two dimensional array of Al₂O₃ (alternately steel, TiB₂, SiC, Si₃N₄, and B₄C) discs, rounds, balls, or other shapes can optionally be inserted in some of the sheets. A three dimensional array will be accomplished by pressing these disc containing sheets along with intermediate monolithic sheets. As to ceramic inserts, both Al₂O₃ and B₄C are commercially available as discs, balls, hexagons, etc. with the former costing about $10/lb. and with B₄C much more costly. Therefore Al₂O₃ is the preferred economic choice and may be obtained in the form of 12-mm diameter×3-mm thick discs. The grade will be 99.5 purity, with density of 3.9 g/cm³, elastic modulus of 370 GPa, and hardness of 14 GPa. As an additional variable, a roll-bonded Nextel™ or carbon steel or stainless steel mesh can be interposed between near surface Mg alloy layers in one pass.

As mentioned above, the property targets are a yield strength of 250 MPa in the matrix, a ductile-to-brittle transition below room temperature, a density of 2.06 g/cm³ (<31 lb/ft² for 1-inch plate) and ballistic results superior to steel and Al alloy 5083 H131 at reduced area density using the standard V50 test methodology recommended by Army Research Laboratory.

On the microstructural level, a grain size of 1 μm; intragranular phase size of <500 nanometers, low texture and low twinning in the matrix are desired. It is anticipated that a 13 volume % of hard ceramic discs, balls, or other shapes arrayed in the composite to cover the planar window to projectiles will be required.

To achieve such a strength increase requires alloy additions and/or material processing. The predominant Mg sheet alloy is AZ31B, which is simplistic in alloy content at 3% Al and is relatively weak compared to Al alloys and steels, unless a very fine grain size is created in this alloy. Ductile-to-brittle transformation for this alloy is above room temperature, where crystallographic twinning is common. More robust alloying of this alloy in sheet form has been limited by concerns regarding plant cross-contamination and by casting and hot/cold working limits. Over the last decade, alloy development of Mg alloys has been inhibited by other barriers as well. In fact, this base element is not a friendly host for extensive alloy strengthening. The alloying elements that improve corrosion resistance and castability, such as Al, unfortunately introduce eutectic intermetallic phases. These surround the primary grains in a coarse and brittle morphology. Furthermore, it is difficult to attain efficient age hardening by fine precipitates within the grains, as exemplified by the case of inefficient Al additions. The elements that promote age hardening, such as rare earth metals, are costly, detrimental to castability and ineffective in resisting corrosion. As a consequence, decade-old Mg alloys such as AZ31B and AZ91D still dominate the tonnage in commercial sheet and casting markets. Increases in yield strength above 180 MPa have been difficult to attain.

An effective means to strengthen Mg in relation to Al and steel is by grain refinement of Mg. By the well-established Hall-Petch relation, strength is proportional to d^{-1/2}, where d=grain size. Furthermore, grain refinement dramatically lowers the ductile/brittle transformation temperature of Mg. Thus, the rare possibility of improving both strength and ductility is offered by grain refinement, but attaining sufficiently fine grain size has not been attained by conventional processes. Whereas conventional Mg sheet and extrusions range from 7 to 90 μm grain size (see Table I), grain size reductions to 1 μm by severe deformation of a Thixomolded® precursor offers a striking opportunity to escalate the strength/density of Mg above the levels of Al and steel. The fine grain in Thixomat's process results from high solidification rates being imposed on the molten alloy due to an 80 to 100° C. lower superheat than conventional casting processes.

TABLE I
Effect of Process on Grain Size of Mg Sheet and Plate

| Process | Condition | Grain Size (μm) |
|---|---|---|
| Direct Cast | As Cast Billet (300 mm) | 2000 |
| Direct Cast | Extruded | 8-90 |
| Twin-roll Cast | As Cast (2-5 mm) | 60-2000 |
| Twin-roll Cast | Hot Rolled | 7-10 |
| FGIM | As Molded | 4-5 |
| FGIM + Rolling | As Rolled | 1 |

Expensive and elaborate schemes to reach 1-μm grain size in Mg have been used elsewhere. One such process entails rapid solidifications of fine powders, plus cold compaction, plus sintering or Hot Isostatic Pressing, plus hot working to achieve sheet form. This powder process is costly and time consuming and has not enjoyed commercial success. Another scheme uses severe deformation by several deformation passes through equal width channels (so called equal channel angular processing, ECAP). ECAP has been practiced in the lab on Mg bar but is not practical for sheet. Thixomat's research showed that changes in alloy composition and use of dispersoid particles in the alloy can take advantage of this simpler TTMP process (see FIG. 1) to produce ultra-fine grain alloys possessing inherently improved ductility. It has been demonstrated that, although hexagonal close packed metals like magnesium have inherent problems with the breakdown of coarse grains due to textural and twinning-related issues, the TTMP process has the capacity to overcome these problems under suitable temperatures and process conditions. These findings prompted the possibility of a synthesis of approaches, to be carried out in a rapid and automated manner in conjunction with Thixomolded® billets that have the advantages of rapid solidification, a fine grain starting size and the facility to rapidly change alloy composition and structure. Further ongoing research has shown that severe plastic deformation of Mg alloys can produce submicron grain sizes in the alloy and simultaneously increase strength and ductility of alloys. A part of the benefit was attributed to elimination of twinning effects.

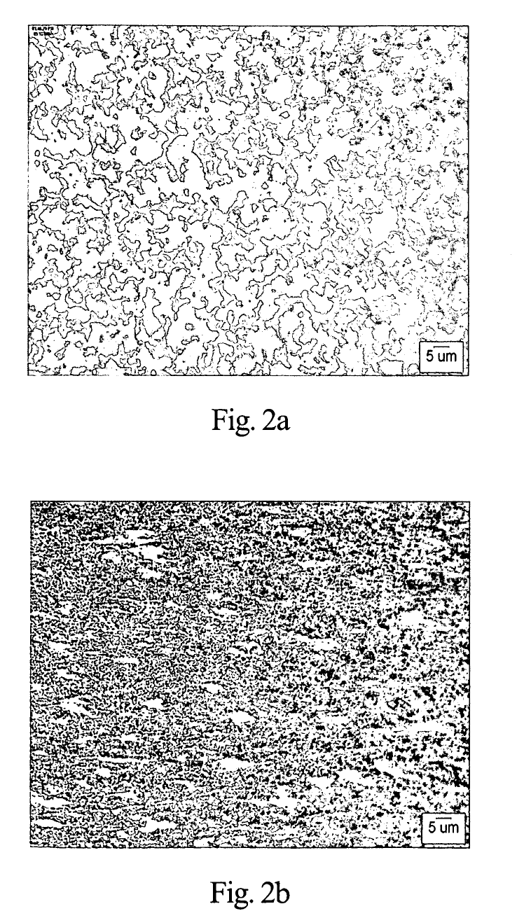

Not only was the grain size refined in the TTMP process, as illustrated in FIGS. 2a and 2b, but the coarse intermetallic phases in the as-molded sheet bar were also refined to the extent that they reported out as nanometer strengthening dispersoids in the final product. Specifically, FIG. 2a is a photo of the microstructure of a sheet bar of AZ64 as Thixomolded® and FIG. 2b is a photo of the microstructure of a Thixomolded® sheet bar of AZ64 that was subsequently directly rolled at 310° C. with a 63% reduction in thickness in a single pass. FIG. 2a illustrates an a phase of 4-7 μm grain size in isotropic and equiaxed morphology. FIG. 2b also illustrates the refined intermetallic grain size generated by continuous dynamic recrystallization induced by the warm direct rolling process. This is thus a low cost technique to introduce nanophases into the sheet, thus avoiding the costly and hazardous handling of fine powders.

Recently and as indicted above, severe deformation has been imposed on Thixomolded® sheet bar by simple rolling. 85% reductions in a single pass have been achieved at 250 to 350° C. Cross rolling reductions of the same magnitude have been made in two passes. Stack bonding (of 2, 3 and 5 layers of sheet bar) were made to magnify the area of the finished sheet; 50% reduction being sufficient to secure firm metallurgical bonding. Thus, the use of the Thixomolded® grain size precursor has avoided the usual 15-step commercial rolling practice needed in commercial plate and sheet. Twinning and texturing were minimized by the continuous dynamic recrystallization afforded in this new process. As seen in Table II, improved properties are generated by this simple severe rolling regime, herein the Mg alloy AM6O. Ductility was enhanced at the same time as strength, as needed and noted previously. In an additional experiment, reinforcing mesh of stainless steel was metallurgically bonded between two sheet bars in one pass of 73% reduction at 350° C.; thus raising the UTS by 41 % and ductility by 42% (compared to the starting sheet bar).

TABLE II
Rolling Experiments on FGIM AM60 Mg Alloy at 350° C.,
3 mm × 100 mm × 150 mm plates

| No. Plates | | 1 PassRolling | TYS, | UTS, | Elongation, |
|---|---|---|---|---|---|
| In Stack | RPM | Reduction, % | MPa | MPa | % |
| Base Plate | N/A | 0 | 140 | 210 | 6 |
| 3 | 45 | 62 | 210 | 298 | 13 |
| 3 | 45 | 70 | 225 | 312 | 24 |
| 3 | 45 | 81 | 237 | 327 | 17 |
| 5 | 45 | 85 | 219 | 317 | 11 |
| 3 | 5 | 58 | 277 | 337 | 9 |

Superplastic forming (SPF) is an attribute associated with fine-grained alloys. This plastic-type property is utilized commercially in autos and aircraft to form complex net shapes in titanium (Ti) and Al. The very nature of SPF enhances solid-state bonding during shaping and pressing. To date, Mg alloys have not enjoyed this advantageous processing in commerce. First, Mg castings do not have the prerequisite grain boundary crystal structure and, secondly, wrought Mg sheet has been too coarse grained and/or too textured for SPF. However, research has demonstrated excellent SPF bonding with TTMP Mg alloy. SPF processing proceeded nicely at modest conditions of 315° C. and 5,000 psi. Studies have also shown that Al₂O₃ and steel bonds well with the Mg matrix. This augers well for enhanced bonding in the final hot pressing step wherein a 1,000 ton press can impart pressures of about 10× the above level.

Turning to a more definitive discussion of nanotechnology, nano-size strengthening phases of <500 nanometers are desirable within the grains. This is another strengthening mechanism, heretofore not available in weakly alloyed AZ31 sheet. However, construction and assembly of such microstructure for bulk structural parts, ab-initio, from nano-powders is very costly and laborious. Also there are safety and health concerns for handling such fine particles in the workplace. It seems to be safer and more practical to generate such nano-strengthening particles in-situ during processing of the already assembled bulk component. With reference to FIG. 2b, it now appears that vigorous thermomechanical working subdivides intermetallic particles into nano-sizes, and, probably, encourages partial solution and more homogeneous reprecipitation of fine arrays within the grains.

Grain size has a major effect on the formability of Mg sheet. In current art, commercial wrought Mg sheet is available mostly in low strength AZ31 alloy. It is fabricated from Direct Cast (DC) slabs (0.3 m thick) with 200 μm grain size (see Table I). Prototype twin roll casting (TRC) is available at 2 to 5-mm thicknesses with 60 to 2000 μm grain sizes. Fabrication from DC or TRC promotes strong texture because of the limited slip systems and twinning occurring in large grain size Mg. Extrusions formed from such base source are also textured to the extent that strength is 50% and toughness is 72% in one direction compared to the cross direction. Thus, grain boundary structure in conventionally prepared magnesium is not favorable to complex deformation without premature fracture, unless an elevated forming temperature is used. Pressing and deep drawing of 3-D shapes is limited by texture and the inherent non-uniform deformation, resulting from twinning. Although twinning in some directions of sheet causes increased elongation during tensile testing, twinning is an impediment to the formation of complex parts due to the anisotropy it produces in coarse grain Mg alloy. Modeling of forming processes and performance in the dies is not reliable with such non-uniformity of structure. The coarse surface finish of present coarse grain Mg alloys also poses a challenge to their acceptance as automotive sheet parts. Fine grain Mg does not exhibit twinning when grain size is below 3 μm, and smooth part surfaces can be attained during forming. Conventional wrought alloy processing uses multiple rolling and annealing operations to produce sheet until the grain size becomes finer. TRC product is typically too thin to refine the grain size below 7 μm by hot processing. The TRC structure also suffers from centerline porosity. Continuous cast Mg may have considerable promise, but currently this technology is not fully developed and many individual pieces of technologies are required for its full implementation, the scope of which is incompatible with small business operations and may not have the flexibility offered by the TTMP process. The many stages involved in breaking down large-grained conventional sheet precursors to produce sheet cause current wrought Magnesium alloys to be expensive, on the order of $18.00 to $35.00/lb.

In the semi-solid metal injection molding process employed by Thixomat (Thixomolding® and Thixomolded®), melt temperatures can be lowered to near liquidus, some 80 to 100° C. lower than in direct-chill casting (DC) or twin roll casting (TRC). These lower temperatures assist in faster cooling to nucleate finer grains upon solidification. Thixomolded® Mg alloys as injection molded are isotropic with 4 to 7-μm grain size (see FIG. 2a). Multiple feeding ports permit rapid Thixomolding® of large sheet bars (dimensions can be 6 mm×400 mm×400 mm) and production rates of about 1 sheet bar/20 seconds. The TTMP treatment imparts large strain to breakdown coarse microstructure and produce new grain boundaries. This process can reduce thickness to 1 mm wherein the sheet dimensions could be about 900×900 mm. Stack rolling and bonding can multiply the sheet area, e.g. doubling with a 2 stack array. The as-molded grain size and a content of Thixomolded® sheet bar are a favorable starting point to attaining sub-micron grain size and low-anisotrophy in the sheet processed by subsequent TTMP processing. Some sub-divided residual R phase may further serve to pin grain boundaries during dynamic recrystallization and heat treatment. The subdividing of this inherently coarse β phase (See FIGS. 2a and 2b) is beneficial to ductility of Mg alloys.

The aforementioned β phase effect is but one aspect of the new opportunities to redesign Mg for this new process. The literature in Mg is replete with new alloying discoveries that have yet to be applied to low cost sheet. These alloying additions are easily reduced to practice by Thixomolding®, especially utilizing its “blending” techniques. Such alloying additions as Ca, Sr, Y, Zr and Zn—Y can now boost the modest strength of the commercial sheet alloy AZ31. The large melts and alloy cross contamination inherent in DC to TRC are avoided by Thixomolding®. Purging of the previous alloy and addition of granules of new blends can be accomplished in minutes in a semi-solid metal injection molding machine (Thixomat's version of which is known as a Thixomolder™), without wasted crucible charges, slag and dross of DC or TRC operations.

Ductility during warm temperature drawing (and superplastic forming) of metals is enhanced by the presence of many grain boundaries. But grain boundaries developed from Mg casting processes are unsuitable for forming applications because they do not permit sliding between grains. Grain boundary character has a major effect on the phenomena of sliding and shearing properties of grain boundaries during deformation. Even at modestly elevated temperatures (150-200° C.) Mg alloys can be formed easily by warm forming process, provided they have fine grain structure (˜1-3 μm grain diameter) and favorable high angle grain boundaries produced by deformation processing. While forming of the alloy at room temperature is preferred, 150-200° C. is not unusual for inexpensive forming applications, since plastics are often formed at such temperatures. Unlike plastics however, Mg parts can be heat treated to grow larger grain size and become creep resistant, or can be alloyed appropriately to make them creep resistant. Low temperature forming can however keep energy usage low during forming and avoid undesirable oxidation encountered during the superplastic forming process.

Rapid solidification during the Thixomolding® process provides fine grain structure, which does not exhibit twinning during subsequent deformation. However, grain boundaries created from the liquid state are crystallographically related, and may possess “special” boundaries which do not permit grain boundary sliding. Special boundaries have a significant fraction of coincident lattice sites (CSL) and low grain boundary energies to make sliding difficult. While the strain contributed by grain boundary sliding is not large during warm forming, if it is capable of providing accommodation locally, it prevents fracture of the material along grain boundaries. Thus, the boundaries required for enhanced formability are not those produced by the casting process but rather, those generated by the plastic working process of severe rolling. The plastic working generates additional dislocations near the grain boundaries and renders them into configurations of higher disorder or higher energy, suitable for enhanced formability. Other approaches are available for such extensive deformation (e.g. equal channel-ECAP, high pressure torsion), but they are not suitable for scale-up nor can they be easily automated for producing thin, wide sheet.

It is anticipated that this process will result in novel light-weight impact resistant structures such as light weight armor that is commercially producible at modest cost.

TTMP does not require the invention of new machines; but rather combines existing commercial machines in a novel concept. The Thixomolding® machines already exist as previously developed by Thixomat and its machine building licensees—to the level of 380 machines with capacities of 100 to 1000 tons. The rolling mill is standard with heated rolls. Likewise, hot presses are widely available.

The TTMP process is clean and free of slag, dross and SF₆. DC and TWC require foundry operations, which, by their very nature, are less environmentally clean, generating slag and dross and requiring SF₆ cover gas (a potent contributor to global warming). TTMP is more flexible as far as alloy base and can generate higher mechanical properties. With an automated cell concept, TTMP will offer less costly net shapes.

As a person skilled in the art will readily appreciate, the above description is meant as an illustration of the implementation of the principles of this invention. This description is not intended to limit the scope or application of this invention in that the invention is susceptible to modification, variation and change, without departing from the spirit of this invention, as defined in the following claims.

1. A high-velocity impact resistant composite member for at least one of armor plate and an impact resistant structure, the member comprising:
a body in plate form including a metal alloy having a fine grain size of about 5 μm or less; and
a reinforcement structure located within the body.

2. The member of claim 1 wherein the metal alloy has a fine grain size of about 1-3 μm.

3. The member of claim 1 wherein the metal alloy is at least one of a magnesium base alloy and an aluminum base alloy.

4. The member of claim 1 wherein the reinforcement structure is formed of a titanium alloy.

5. The member of claim 1 wherein the reinforcement structure is formed of steel.

6. The member of claim 1 wherein the reinforcement structure is formed of a ceramic material.

7. The member of claim 6 wherein the ceramic material is one of aluminum oxide, titanium boride, titanium diboride, silicon carbide, silicon nitride and boron carbide.

8. The member of claim 1 wherein the body is formed of a plurality of layers.

9. The member of claim 1 wherein the reinforcement structure is formed of a plurality of layers.

10. The member of claim 9 wherein at least one of the layers of the reinforcement structure includes ceramic bodies in a metal alloy sheet.

11. The member of claim 10 wherein the ceramic bodies are configured as one of disks and spheres.

12. The member of claim 10 wherein another one of the layers of the reinforcement structure includes one of wire mesh, fiber mesh and grid.

13. The member of claim 9 wherein at least one of the layers of the reinforcement structure includes steel bodies in a metal alloy sheet, the steel bodies being configured as one of disks, spheres and grid.

14. The member of claim 1 wherein the reinforcement structure includes a high strength metal alloy sheet which is formed from a metal alloy having higher strength and lower ductility than the metal alloy of the body.

15. The member of claim 14 wherein the high strength metal alloy sheet is formed from a magnesium/aluminum/zinc alloy.

16. The member of claim 14 wherein the high strength metal alloy sheet forms one side of the plate form of the body and the metal alloy forms an opposing side of the plate form of the body.

17. A method of forming a high-velocity impact resistant composite member for at least one of armor plate and an impact resistant structure, the method comprising:
providing a plurality of precursor members of a metal alloy material having a grain size about 5 μm or less;
refining the grain size of the precursor members to about 1-3 μm or less to form a plurality of precursor layers;
forming a reinforcement structure;
locating the reinforcement structure with the precursor layers to form a multilayer stack of an initial thickness; and
bonding the layers of the multilayer stack to form a bonded multilayer stack.

18. The method of claim 17 wherein the step of locating the reinforcement structure includes positioning the reinforcement structure between two of the precursor layers.

19. The method of claim 17 wherein the step of refining the grain size of the precursor members includes physically compressing the precursor members and reducing their thicknesses.

20. The method of claim 17 wherein the step of forming the reinforcement structure includes locating reinforcement bodies within one of the plurality of precursor layers.

21. The method of claim 17 wherein the step of forming the reinforcement structure includes locating ceramic members within one of the plurality of precursor layers to form a reinforcement layer.

22. The method of claim 21 wherein the step of locating the reinforcement structure includes positioning the reinforcement layer as an outermost layer of the multilayer stack and the step of bonding the layers includes forming the reinforcement layer so as to include an external surface of the bonded multilayer stack.

23. The method of claim 21 wherein the step of forming the reinforcement structure includes forming a plurality of reinforcement layers.

24. The method of claim 23 wherein the step of forming the reinforcement structure locates the ceramic members such that the ceramic members are offset from one another in adjacent reinforcement layers.

25. The method of claim 24 wherein the step of locating the reinforcement structure includes positioning at least one precursor layer between two adjacent reinforcement layers, reducing interference and cracking of the ceramic members during the step of bonding the layers.

26. The method of claim 24 wherein the step of forming the reinforcement structure includes locating one of a wire mesh, fiber mesh and grid within one of the plurality of precursor layers to form a continuously reinforced layer and the step of locating the reinforcement structure includes positioning the continuously reinforced layer between two adjacent reinforcement layers, reducing distortion of the reinforcement layers during the step of bonding the layers.

27. The method of claim 17 wherein the step of providing a plurality of precursor members provides precursor members formed of one of magnesium base alloy material and aluminum base alloy material.

28. The method of claim 17 wherein the step of refining the grain size of the precursor members reduces their thickness by at least 50%.

29. The method of claim 17 wherein the step of bonding the layers of the multilayer stack includes physically compressing the multilayer stack thereby forming a bonded multilayer stack of reduced thickness.

30. The method of claim 29 wherein the step of compressing the multilayer stack is done by superplastic press forming.

31. The method of claim 29 wherein the step of compressing the multilayer stack is done by roll bonding.

32. The method of claim 29 wherein the step of bonding the layers of the multilayer stack further includes adhesively bonding the multilayer stack.

33. The method of claim 29 wherein the step of bonding the layers of the multilayer stack further includes diffusion bonding the multilayer stack.

34. The method of claim 29 wherein the step of bonding the layers of the multilayer stack further includes weld stitching the multilayer stack.

35. The method of claim 29 wherein the step of bonding the layers of the multilayer stack further includes friction stir welding the multilayer stack.

36. The method of claim 29 wherein the step of bonding the layers of the multilayer stack further includes heating the multilayer stack.

37. The method of claim 36 wherein the step of bonding the layers of the multilayer stack further includes gradual cooling of the bonded multilayer stack, reducing delamination of the bonded multilayer stack.

38. The method of claim 29 wherein the step of providing a plurality of precursor members provides precursor members formed of magnesium alloy material and the step of forming the reinforcement structure includes locating ceramic members within at least one of the plurality of precursor layers to form at least one reinforcement layer.

39. The method of claim 29 wherein at least two reinforcement layers are formed with the ceramic members therein and the step of forming the reinforcement structure further includes locating one of a wire mesh, fiber mesh and grid within one of the plurality of precursor layers to form a continuously reinforced layer and the step of locating the reinforcement structure includes positioning the continuously reinforced layer between the at least two reinforcement layers, reducing distortion of the reinforcement layers during the step of bonding the layers.

40. The method of claim 17 wherein the step of bonding the layers of the multilayer stack further includes adhesively bonding the multilayer stack.

41. The method of claim 17 wherein the step of bonding the layers of the multilayer stack further includes diffusion bonding the multilayer stack.

42. The method of claim 17 wherein the step of bonding the layers of the multilayer stack further includes weld stitching the multilayer stack.

43. The method of claim 17 wherein the step of bonding the layers of the multilayer stack further includes friction stir welding the multilayer stack.

44. A method of forming a high-velocity impact resistant composite member for at least one of armor plate and an impact resistant structure, the method comprising:
providing a plurality of precursor members of a metal alloy material having a grain size about 5 μm or less;
refining the grain size of the precursor members to about 1-3 μm or less to form a plurality of precursor layers;
forming a reinforcement structure including at least one reinforcement body that has a lower coefficient of thermal expansion (CTE) than a CTE of the metal alloy material;
locating the reinforcement structure with the precursor layers to form a multilayer stack of an initial thickness; and
bonding the layers of the multilayer stack to form a bonded multilayer stack including squeeze shrink-fitting the at least one reinforcement body within the metal alloy material.

45. The method of claim 45 wherein the reinforcement body is formed of a titanium alloy.

46. The method of claim 45 wherein the reinforcement body is formed of steel.

47. The method of claim 45 wherein the reinforcement body is formed of a ceramic material.
